(19) United States
(12) Patent Application Publication
(10) Pub. No.: US 2026/0131466 A1
(43) Pub. Date: May 14, 2026

(54) ROBOT SYSTEM

(71) Applicant: Gyrobot Technology (Suzhou) Co., Ltd., Suzhou (CN)

(72) Inventors: SENG THOR ANG, Suzhou (CN); Weifeng XU, Suzhou (CN); Jie DENG, Suzhou (CN)

(73) Assignee: Gyrobot Technology (Suzhou) Co., Ltd., Suzhou (CN)

(21) Appl. No.: 19/383,426

(22) Filed: Nov. 7, 2025

(30) Foreign Application Priority Data
Nov. 13, 2024 (CN) 202411613219.9

(51) Int. Cl. B25J 9/16; B25J 11/00; B25J 13/08

(52) U.S. Cl. CPC B25J 9/1669; B25J 11/0095; B25J 13/088

(57) ABSTRACT

The disclosure provides a robot system, including: a vehicle main body; a grasping mechanism, disposed on the vehicle main body; and a material tray, including a fixed material tray fixedly disposed on the vehicle main body and a sliding material tray slidably disposed on the vehicle main body in a first direction, both the fixed material tray and the sliding material tray are provided with loading stations, the vehicle main body is provided with an initial position located directly below the fixed material tray and a feeding position located on one side of the fixed material tray in the first direction. While the grasping mechanism grasps the object, the sliding material tray moves from the initial position to the feeding position, and the grasping mechanism places the grasped object on the loading station of the sliding material tray located at the feeding position.

### CROSS-REFERENCE TO RELATED APPLICATION

The present application claims priority to Chinese Patent Application No. 202411613219.9, filed on November 13, 2024. The disclosure of the above-referenced application is hereby incorporated by reference in its entirety.

### BACKGROUND

A wafer is a basic raw material for manufacturing a semiconductor device. A very high-purity semiconductor is manufactured into a wafer through processes such as crystal pulling and slicing. The wafer is subjected to a series of semiconductor manufacturing processes to form a very small circuit structure, and then is cut, packaged, and tested to form an IC chip, which is widely applied to various electronic devices.

A tray, as a container for carrying a semiconductor device, is typically molded from conductive or electrically dissipative plastic or carbon fiber materials to protect a static sensitive device. The tray is commonly configured for the pick-up and placement of an IC chip, with an outer structure having standardized dimensions and an inner structure having regularly arranged cavities for carrying individual IC chips of a particular package. The trays may be stacked by adding a plurality of new trays to the top structure of the trays, facilitating packaging and shipping.

A tray carrier is configured to carry a plurality of trays for batch processing during production and transportation. The dimensions and shape of the tray carrier are adapted to the tray to ensure that the tray is closely attached to the inner structure of the tray carrier during transportation.

In an existing robot system, a mechanical jaw is used to grasp a tray and a tray carrier. Driven by a manipulator, the mechanical jaw transports the tray or the tray carrier above a receiving tray, and the jaw is released to place the tray or the tray carrier on the receiving tray. Since both the upper and lower receiving trays of the robot are of a fixed structure and thus their positions cannot be adjusted, when the tray or the tray carrier needs to be placed on the lower receiving tray, a mechanical arm has to move for a long distance to drive the clamping jaw to reach the position of the receiving tray and then perform the release action. As a result, the time and cost for transportation are increased, and since the position of the receiving tray is narrow, the mechanical arm may scratch components around the receiving tray when driving the clamping jaw to move, causing damage to the robot, which is not conducive to the safety of the robot.

Therefore, how to provide a high-efficiency robot system is a technical problem that needs to be urgently resolved by a person skilled in the art.

### SUMMARY

To resolve the problems in the prior art, the present disclosure provides a robot system to resolve one or more technical problems in the prior art.

The present disclosure relates to the field of object handling technologies, and in particular, to a robot system.

The present disclosure provides a robot system, including:

a vehicle main body;

a grasping mechanism, disposed on the vehicle main body, where the grasping mechanism is configured to grasp and convey objects; and

a material tray, disposed on the vehicle main body, where the material tray includes a fixed material tray fixedly disposed on the vehicle main body and a sliding material tray slidably disposed on the vehicle main body in a first direction, both the fixed material tray and the sliding material tray are provided with loading stations, the vehicle main body is provided with an initial position located directly below the fixed material tray and a feeding position located on one side of the fixed material tray in the first direction, and the sliding material tray is configured to move between the initial position and the feeding position.

The sliding material tray moves from the initial position to the feeding position while the grasping mechanism grasps the object, and the grasping mechanism places the grasped object on the loading station of the sliding material tray located at the feeding position.

The robot system introduces a slidable material tray, which effectively solves the problem of low transportation efficiency and safety caused by the traditional material tray structure. While the grasping mechanism grasps the object, the sliding material tray moves outwards, so that the sliding material tray is closer to the grasping mechanism, thereby reducing the movement distance of the grasping mechanism, improving the transportation efficiency, and optimizing the operation process. In addition, such an arrangement also reduces the risk of the grasping mechanism and components around the material tray scraping each other, and enhances the safety and durability of the robot system.

Preferably, a plurality of sliding material trays are provided, and each sliding material tray is provided with a plurality of loading stations.

With the arrangement of the plurality of loading stations on the sliding material tray, a plurality of objects can be processed simultaneously, thereby improving the operation efficiency and increasing the flexibility and processing capacity of the system.

Preferably, the robot system further includes a first detection mechanism. The first detection mechanism is disposed on the loading station and configured to transmit a first detection signal in a second direction to detect whether the object is located on the loading station. A preset included angle is maintained between the second direction and the first direction.

With the arrangement of the first detection mechanism, whether there is an object on the loading station can be detected, thereby improving the accuracy and reliability of the operation, and further facilitating the execution of subsequent operations.

Preferably, the robot system further includes a main controller and a second detection mechanism; the second detection mechanism is configured to detect a quantity of the objects located on the loading stations of the sliding material tray.

The first detection mechanism detects that the objects are located on the loading stations and transmits in-position signals to the second detection mechanism, the second detection mechanism counts, within a preset time, a quantity of the in-position signals received and transmits the signals to the main controller, and the main controller determines whether a quantity of the objects located on the loading stations of the sliding material tray meets a preset quantity value based on the quantity of the in-position signals; if so, the sliding material tray on which the objects are placed is reset from the feeding position to the initial position.

Through the coordinated operation of the first detection mechanism and the second detection mechanism, the system can detect and count the quantity of the objects on the loading stations, and the sliding material tray will be reset to the initial position only when the quantity of the objects placed on the loading stations of the sliding material tray reaches the preset value.

Preferably, if the quantity of the objects located on the loading stations of the sliding material tray does not meet the preset quantity value, the grasping mechanism continues to grasp the objects and places the objects on the loading stations of the sliding material tray located at the feeding position until the main controller determines that the quantity of the objects located on the loading stations of the sliding material tray reaches the preset quantity value, and then the grasping mechanism stops.

When the quantity of the objects placed on the loading stations of the sliding material tray does not reach the preset value, the grasping mechanism continues to grasp the objects and transport the objects to the loading stations until the quantity of the objects reaches the preset value, and the sliding material tray is reset to the initial position, so that the fully automated handling and storage process of objects is realized. In addition, the system ensures that the sliding material tray is reset to the initial position only when the quantity of the objects reaches the preset value, thereby avoiding unnecessary mechanical movement and reducing the wear of the robot.

Preferably, the object includes a first object and a second object.

Several first blocking members and several second blocking members are disposed in the loading station, the first blocking member defines a first position for limiting the first object in an enclosing manner, the second blocking member encloses a periphery of the first blocking member, the second blocking member defines a second position for limiting the second object in an enclosing manner, and at least part of the second blocking member extends above the first blocking member.

With the arrangement of the first blocking member and the second blocking member, different types of objects can be fixed, thereby improving the use efficiency of the material tray and enhancing the flexibility and adaptability of the loading station. At the same time, the arrangement of the first blocking member and the second blocking member helps to improve the positioning accuracy of the object on the loading station and ensure the accuracy of the object at a predetermined position.

Preferably, the grasping mechanism includes a mechanical arm assembly and a manipulator assembly. The manipulator assembly is configured to grasp the objects; the mechanical arm assembly includes several shaft bodies connected in series, one end of the shaft body is disposed at a top end of the vehicle main body, and the other end of the shaft body is connected to the manipulator assembly; different shaft bodies all have a degree of freedom greater than 0 to drive the manipulator assembly to move in any direction.

The mechanical arm assembly adopts a design of a plurality of serially connected shaft bodies, so that the manipulator assembly can move in any direction, and thus the operation flexibility and adaptability of the robot are improved. Different shaft bodies have a degree of freedom greater than 0, so that the operation range of the mechanical arm is increased, and thus the manipulator assembly can perform accurate position control and movement coordination, thereby improving the operation efficiency.

Preferably, the manipulator assembly includes at least one pair of grasping units; adjacent grasping units move in a direction distal to each other to engage a snap-fit structure at a top end of the object, or move in directions proximal to each other to disconnect the grasping units from the snap-fit structure and release the object.

The grasping units can move in a direction distal to each other to grasp the snap-fit structure at the top end of the object, or move in directions proximal to each other to release the object, which ensures the reliability of grasping and releasing the object, avoids the damage or falling off of the object due to improper operation, and improves the safety of the system.

Preferably, the grasping mechanism further includes a plurality of groups of connecting mechanisms, one end of the connecting mechanism is connected to one end of the shaft body distal to the vehicle main body, and the other end of the connecting mechanism is connected to the manipulator assembly with different specifications.

With the arrangement of the plurality of groups of connecting mechanisms, the robot system can adapt to the grasping mechanism with different specifications, so that the robot can quickly adjust and replace the manipulator assembly based on the type of the object during operation to meet specific operation requirements. In addition, the plurality of groups of connecting mechanisms may operate in coordination with a plurality of pairs of grasping mechanisms simultaneously to improve the operation efficiency.

Preferably, the robot system further includes a stage and a sliding mechanism. The sliding material tray is disposed below the fixed material tray and mounted on a surface of the stage through the sliding mechanism.

The sliding mechanism includes a sliding rail and a sliding stage disposed on the sliding rail, and the sliding material tray moves along the sliding rail through the sliding stage.

The sliding material tray is located below the fixed material tray, so that the multi-level goods storage is realized in a limited space, and the space utilization efficiency is optimized. The sliding mechanism includes the sliding rail and the sliding stage, which ensures that the sliding material tray can move between the initial position and the feeding position along a predetermined trajectory.

Preferably, the material tray is symmetrically disposed on both sides of the vehicle main body, and on one side of the vehicle main body, at least three loading stations are disposed on each of the sliding material tray and the fixed material tray.

The material tray is symmetrically disposed on both sides of the vehicle main body, and each side is provided with at least three loading stations, which significantly improves the space utilization rate, allows the robot system to accommodate more goods in a limited space, and meanwhile, provides more flexibility to process different types of objects.

According to the specific embodiments provided in the present disclosure, the following technical effects are disclosed:

In the technical solutions of the present disclosure, a robot system is provided, including: a vehicle main body; a grasping mechanism, disposed on the vehicle main body, where the grasping mechanism is configured to grasp and convey objects; and a material tray, disposed on the vehicle main body, where the material tray includes a fixed material tray fixedly disposed on the vehicle main body and a sliding material tray slidably disposed on the vehicle main body in a first direction, both the fixed material tray and the sliding material tray are provided with loading stations, the vehicle main body is provided with an initial position located directly below the fixed material tray and a feeding position located on one side of the fixed material tray in the first direction, and the sliding material tray is configured to move between the initial position and the feeding position. While the grasping mechanism grasps the object, the sliding material tray moves from the initial position to the feeding position, and the grasping mechanism places the grasped object on the loading station of the sliding material tray located at the feeding position. According to the solutions, the robot system introduces a slidable material tray, which effectively solves the problem of low transportation efficiency and safety caused by the traditional material tray structure. While the grasping mechanism grasps the object, the sliding material tray moves outwards, so that the sliding material tray is closer to the grasping mechanism, thereby reducing the movement distance of the grasping mechanism and improving the transportation efficiency. In addition, such an arrangement also reduces the risk of the grasping mechanism and components around the material tray scraping each other, and enhances the safety and durability of the robot system.

### BRIEF DESCRIPTION OF DRAWINGS

To describe the technical solutions in embodiments of the present disclosure or in the prior art more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of a sliding material tray of a robot system in a non-slid-out state according to an embodiment of the present disclosure;

FIG. 2 is a schematic diagram of a sliding material tray of a robot system in a slid-out state according to an embodiment of the present disclosure;

FIG. 3 is a schematic diagram of carrying a first object on a loading station according to an embodiment of the present disclosure;

FIG. 4 is a schematic diagram of carrying a second object on a loading station according to an embodiment of the present disclosure;

FIG. 5 is a schematic diagram of a sliding material tray according to an embodiment of the present disclosure; and

FIG. 6 is a schematic diagram of a grasping mechanism according to an embodiment of the present disclosure.

Description of reference numerals: 10. vehicle main body; 20. grasping mechanism; 30. material tray; 31. loading station; 40. connecting mechanism; 50. stage; 51. sliding rail; 52. sliding stage; 200. mechanical arm assembly; 201. first shaft body; 202. second shaft body; 203. third shaft body; 204. fourth shaft body; 210. manipulator assembly; 211. grasping unit; 300. fixed material tray; 310. sliding material tray; 311. first blocking member; 312. second blocking member; 313. wafer cassette; 314. tray carrier; 3100. first detection mechanism; 3110. third detection mechanism; 3120. fourth detection mechanism; 3140. second detection mechanism; 3130. snap-fit structure.

### DETAILED DESCRIPTION OF THE EMBODIMENTS

Some embodiments of the present disclosure will be described below with reference to the accompanying drawings. It should be understood by those skilled in the art that these embodiments are only used to explain the technical principles of the present disclosure and are not intended to limit the protection scope of the present disclosure.

As described in the background art, in an existing robot system, a mechanical jaw is used to grasp a tray and a tray carrier. Driven by a manipulator, the mechanical jaw transports the tray or the tray carrier above a receiving tray, and the jaw is released to place the tray or the tray carrier on the receiving tray. Since both the upper and lower receiving trays of the robot are of a fixed structure and thus their positions cannot be adjusted, when the tray or the tray carrier needs to be placed on the lower receiving tray, a mechanical arm has to move for a long distance to drive the clamping jaw to reach the position of the receiving tray and then perform the release action. As a result, the time and cost for transportation are increased, and since the position of the receiving tray is narrow, the mechanical arm may scratch components around the receiving tray when driving the clamping jaw to move, causing damage to the robot, which is not conducive to the safety of the robot.

To resolve one or more technical problems described above, the present disclosure provides a robot system, aiming to improve operation efficiency.

Embodiment 1

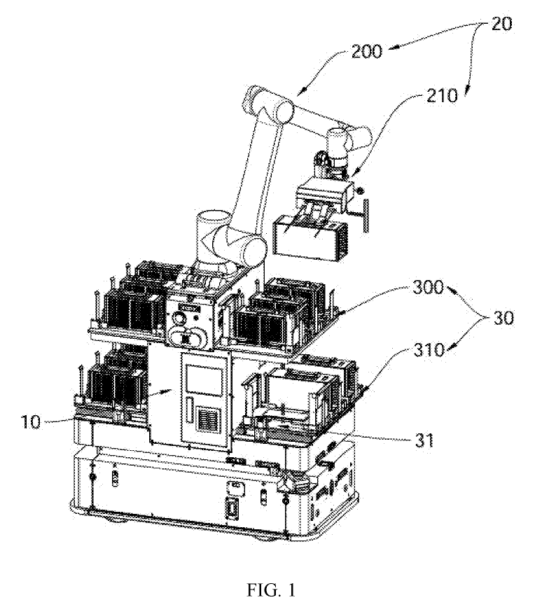

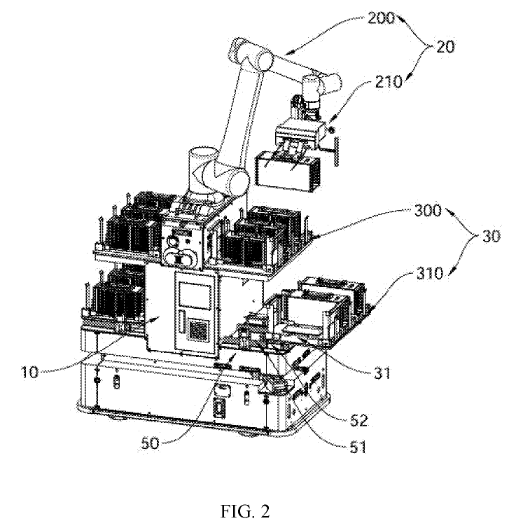

Embodiment 1 of the present disclosure provides a robot system. Referring to schematic diagrams of the robot system shown in FIGS. 1 and 2, the robot system includes: a vehicle main body 10; a grasping mechanism 20, disposed on the vehicle main body 10, where the grasping mechanism 20 is configured to grasp and convey objects; and a material tray 30, disposed on the vehicle main body 10, where the material tray 30 includes a fixed material tray 300 fixedly disposed on the vehicle main body 10 and a sliding material tray 310 slidably disposed on the vehicle main body 10 in a first direction, both the fixed material tray 300 and the sliding material tray 310 are provided with loading stations 31, the vehicle main body 10 is provided with an initial position located directly below the fixed material tray 300 and a feeding position located on one side of the fixed material tray 300 in the first direction, and the sliding material tray 310 is configured to move between the initial position and the feeding position. While the grasping mechanism 20 grasps the object, the sliding material tray 310 moves from the initial position to the feeding position, and the grasping mechanism 20 places the grasped object on the loading station of the sliding material tray 310 located at the feeding position.

The robot system introduces a slidable material tray, which effectively solves the problem of low transportation efficiency and safety caused by the traditional material tray structure. While the grasping mechanism 20 grasps the object, the sliding material tray 310 moves outwards, so that the sliding material tray 310 is closer to the grasping mechanism 20, thereby reducing the movement distance of the grasping mechanism 20, improving the transportation efficiency, and optimizing the operation process. In addition, such an arrangement also reduces the risk of the grasping mechanism 20 and components around the material tray 30 scraping each other, and enhances the safety and durability of the robot system.

In some embodiments of the present disclosure, the grasping mechanism 20 includes a mechanical arm and a manipulator. The manipulator is configured to grasp the object, and the mechanical arm is configured to drive the manipulator to move to a specified position.

In some embodiments of the present disclosure, the sliding material tray 310 may adopt a sliding mechanism, such as a combination of a sliding rail and a sliding stage, or a sliding limiting apparatus, such as a combination of a stop seat and a stop assembly, so as to achieve the sliding of the material tray.

In some embodiments of the present disclosure, the first direction is a height direction perpendicular to the vehicle main body 10.

Preferably, a plurality of sliding material trays 310 are provided, and each sliding material tray 310 is provided with a plurality of loading stations 31.

With the arrangement of the plurality of sliding material trays 310 and the arrangement of the plurality of loading stations 31 on the sliding material tray 310, a plurality of objects can be processed simultaneously, thereby improving the operation efficiency and increasing the flexibility and processing capacity of the system.

In some embodiments of the present disclosure, the vehicle main body 10 is approximately a cuboid as a whole, the fixed material tray 300 is disposed at the top end of the vehicle main body 10, a plurality of sliding material trays 310 are sequentially arranged below the fixed material tray 300, and each sliding material tray 310 is provided with a plurality of loading stations 31.

Preferably, the robot system further includes a first detection mechanism 3100. The first detection mechanism 3100 is disposed on the loading station 31 and configured to transmit a first detection signal in a second direction to detect whether the object is located on the loading station 31. A preset included angle is maintained between the second direction and the first direction.

With the arrangement of the first detection mechanism 3100, whether there is an object on the loading station 31 can be detected, thereby improving the accuracy and reliability of the operation, and further facilitating the execution of subsequent operations.

In some embodiments of the present disclosure, the first detection mechanism 3100 is a laser sensor, the first detection signal is a laser signal transmitted by the laser sensor, and an included angle of 90° is maintained between the second direction and the first direction.

Preferably, the robot system further includes a main controller (not shown in the figure) and a second detection mechanism 3140. The second detection mechanism 3140 is configured to detect the quantity of objects located on the loading stations 31 of the sliding material tray 310; the first detection mechanism 3100 detects that the objects are located on the loading stations 31 and transmits in-position signals to the second detection mechanism 3140, the second detection mechanism 3140 counts, within a preset time, the quantity of the in-position signals received and transmits the signals to the main controller, and the main controller determines whether the quantity of the objects located on the loading stations 31 of the sliding material tray 310 meets a preset quantity value based on the quantity of the in-position signals; if so, the sliding material tray 310 on which the objects are placed is reset from the feeding position to the initial position.

Through the coordinated operation of the first detection mechanism 3100 and the second detection mechanism 3140, the system can detect and count the quantity of the objects on the loading stations 31, and the sliding material tray 310 will be reset to the initial position only when the quantity of the objects placed on the loading stations 31 of the sliding material tray 310 reaches the preset value.

Preferably, if the quantity of the objects located on the loading stations 31 of the sliding material tray 310 does not meet the preset quantity value, the grasping mechanism 20 continues to grasp the objects and places the objects on the loading stations 31 of the sliding material tray 310 located at the feeding position until the main controller determines that the quantity of the objects located on the loading stations 31 of the sliding material tray 310 reaches the preset quantity value, and then the grasping mechanism 20 stops.

When the quantity of the objects placed on the loading stations 31 of the sliding material tray 310 does not reach the preset value, the grasping mechanism 20 continues to grasp the objects and transport the objects to the loading stations until the quantity of the objects reaches the preset value, and the sliding material tray 310 is reset to the initial position, so that the fully automated handling and storage process of objects is realized. In addition, the system ensures that the sliding material tray 310 is reset to the initial position only when the quantity of the objects reaches the preset value, thereby avoiding unnecessary mechanical movement and reducing the wear of the robot.

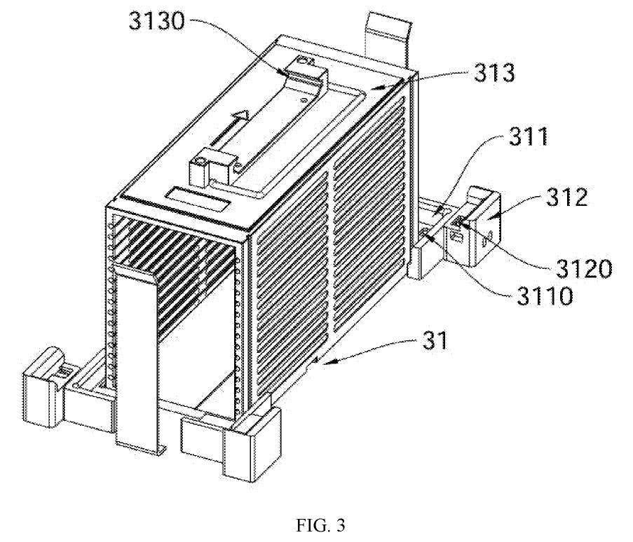

Preferably, referring to FIGS. 3 to 5, the object includes a first object and a second object; several first blocking members 311 and several second blocking members 312 are disposed in the loading station 31. The first blocking member 311 defines a first position for limiting the first object in an enclosing manner, the second blocking member 312 encloses the periphery of the first blocking member 311, the second blocking member 312 defines a second position for limiting the second object in an enclosing manner, and at least part of the second blocking member 312 extends above the first blocking member 311.

With the arrangement of the first blocking member 311 and the second blocking member 312, different types of objects can be fixed, thereby improving the use efficiency of the material tray and enhancing the flexibility and adaptability of the loading station 31. At the same time, the arrangement of the first blocking member 311 and the second blocking member 312 helps to improve the positioning accuracy of the object on the loading station 31 and ensure the accuracy of the object at a predetermined position.

In some embodiments of the present disclosure, referring to a schematic diagram of carrying a first object on a loading station shown in FIG. 3, the first object is a wafer cassette 313. The wafer cassette 313 is placed at a first position enclosed by the first blocking member 311, and four corners of the wafer cassette 313 abut against four first blocking members 311, respectively. The four first blocking members 311 are all of a hollow structure with a third detection mechanism 3110 disposed therein for detecting whether the position of the wafer cassette 313 is aligned with the first blocking member 311.

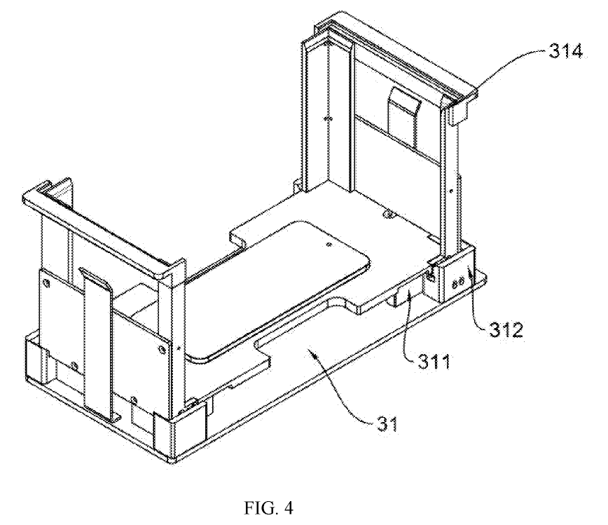

In some embodiments of the present disclosure, referring to a schematic diagram of carrying a second object on a loading station shown in FIG. 4, the second object is a tray or a tray carrier 314. The tray or the tray carrier 314 is placed at a second position enclosed by the second blocking member 312, and four corners of the tray or the tray carrier 314 abut against four second blocking members 312, respectively. The four second blocking members 312 are all of a hollow structure with a fourth detection mechanism 3120 disposed therein for detecting whether the position of the tray or the tray carrier 314 is aligned with the second blocking member 312.

Preferably, the grasping mechanism 20 includes a mechanical arm assembly 200 and a manipulator assembly 210. The manipulator assembly 210 is configured to grasp the objects; the mechanical arm assembly 200 includes several shaft bodies connected in series, one end of the shaft body is disposed at the top end of the vehicle main body 10, and the other end of the shaft body is connected to the manipulator assembly 210; different shaft bodies all have a degree of freedom greater than 0 to drive the manipulator assembly 210 to move in any direction.

The mechanical arm assembly 200 adopts a design of a plurality of serially connected shaft bodies, so that the manipulator assembly 210 can move in any direction, and thus the operation flexibility and adaptability of the robot are improved. Different shaft bodies have a degree of freedom greater than 0, so that the operation range of the mechanical arm is increased, and thus the manipulator assembly 210 can perform accurate position control and movement coordination, thereby improving the operation efficiency.

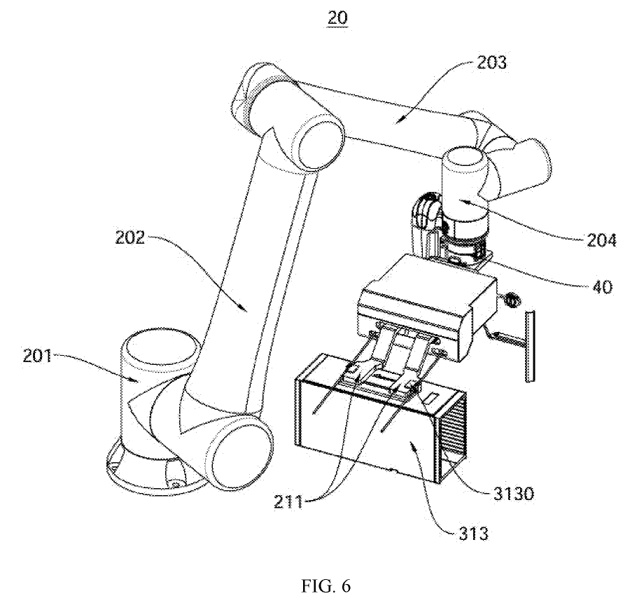

In some embodiments of the present disclosure, referring to a schematic diagram of a grasping mechanism shown in FIG. 6, the mechanical arm assembly 200 consists of a first shaft body 201, a second shaft body 202, a third shaft body 203, and a fourth shaft body 204 connected end to end sequentially. The four shaft bodies all have a degree of freedom greater than 0 and cooperate with each other to realize the movement of the manipulator assembly 210 in any direction.

Preferably, referring to a schematic diagram of carrying a first object on a loading station shown in FIG. 3 and a schematic diagram of a grasping mechanism shown in FIG. 6, the manipulator assembly 210 includes at least one pair of grasping units 211; adjacent grasping units 211 move in a direction distal to each other to engage a snap-fit structure 3130 at the top end of the first object, or move in directions proximal to each other to disconnect the grasping units 211 from the snap-fit structure 3130 and release the object.

The grasping units 211 can move in a direction distal to each other to grasp the snap-fit structure 3130 at the top end of the object, or move in directions proximal to each other to release the object, which ensures the reliability of grasping and releasing the object, avoids the damage or falling off of the object due to improper operation, and improves the safety of the system.

Preferably, the grasping mechanism 20 further includes a plurality of groups of connecting mechanisms 40, one end of the connecting mechanism 40 is connected to one end of the shaft body distal to the vehicle main body 10, and the other end of the connecting mechanism is connected to the manipulator assembly 210 with different specifications.

Preferably, referring to a schematic diagram of a sliding material tray of a robot system in a slid-out state shown in FIG. 2, the robot system further includes a stage 50 and a sliding mechanism. The sliding material tray 310 is disposed below the fixed material tray 300 and mounted on the surface of the stage 50 through the sliding mechanism. The sliding mechanism includes a sliding rail 51 and a sliding stage 52 disposed on the sliding rail 51, and the sliding material tray 310 moves along the sliding rail 51 through the sliding stage.

With the arrangement of the plurality of groups of connecting mechanisms 40, the robot system can adapt to the grasping mechanism 20 with different specifications, so that the robot can quickly adjust and replace the manipulator assembly based on the type of the object during operation to meet specific operation requirements. In addition, the plurality of groups of connecting mechanisms 40 may operate in coordination with a plurality of pairs of manipulator assemblies 210 simultaneously to improve the operation efficiency.

The sliding material tray 310 is located below the fixed material tray 300, so that the multi-level goods storage is realized in a limited space, and the space utilization efficiency is optimized. The sliding mechanism includes the sliding rail 51 and the sliding stage 52, which ensures that the sliding material tray 310 can move between the initial position and the feeding position along a predetermined trajectory.

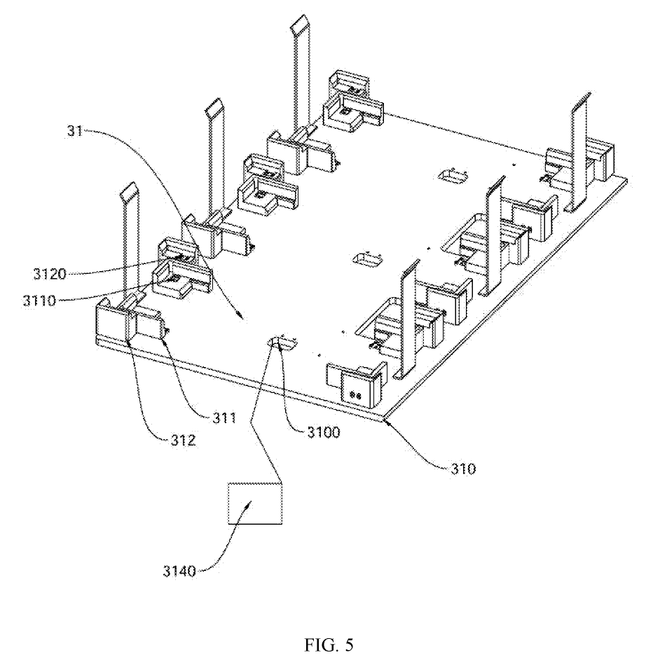

Preferably, referring to schematic diagrams of a robot system shown in FIGS. 1 and 2 and a schematic diagram of a sliding material tray shown in FIG. 5, the material tray 30 is symmetrically disposed on both sides of the vehicle main body 10, and on one side of the vehicle main body 10, at least three loading stations 31 are disposed on each of the sliding material tray 310 and the fixed material tray 300.

The material tray 30 is symmetrically disposed on both sides of the vehicle main body 10, and each side is provided with at least three loading stations 31, which significantly improves the space utilization rate, allows the robot system to accommodate more objects in a limited space, and meanwhile, provides more flexibility to process different types of objects.

Embodiment 2

Based on Embodiment 1, Embodiment 2 of the present disclosure provides an interaction method for a sliding material tray and a grasping mechanism, including:

In S1, the grasping mechanism grasps an object.

In S2, the sliding material tray moves from the initial position of the vehicle main body to the feeding position.

In S3, the grasping mechanism places the grasped object on the loading station of the sliding material tray at the feeding position.

The robot system introduces a slidable material tray, which effectively solves the problem of low transportation efficiency and safety caused by the traditional material tray structure. While the grasping mechanism grasps the object, the sliding material tray moves outwards, so that the sliding material tray is closer to the grasping mechanism, thereby reducing the movement distance of the grasping mechanism, improving the transportation efficiency, and optimizing the operation process. In addition, such an arrangement also reduces the risk of the grasping mechanism and components around the material tray scraping each other, and enhances the safety and durability of the robot system.

In the description of the specification, the description of reference terms “one embodiment”, “some embodiments”, “an example”, “a specific example”, or “some examples” and the like means that specific features, structures, materials, or characteristics described in connection with the embodiments or examples are included in at least one embodiment or example of the present disclosure. In this specification, the schematic description of the above terms does not necessarily refer to the same embodiment or example. Moreover, the specific feature, structure, material, or characteristic described may be combined in a suitable manner in any one or more embodiments or examples.

In addition, the terms “first” and “second” are used herein for descriptive purposes only and should not be construed as indicating or implying relative importance or implicitly indicating the quantity of technical features described. Thus, a feature defined by “first” or “second” may explicitly or implicitly include at least one such feature. In the description of the present disclosure, “plurality” means at least two, e.g., two or three, unless otherwise explicitly and specifically defined.

Although the embodiments of the present disclosure have been shown and described above, it will be understood that the above embodiments are exemplary and not to be construed as limiting the present disclosure. Those of ordinary skill in the art can make changes, modifications, substitutions, and variations to the above embodiments within the scope of the present disclosure.

What is claimed is:

1. A robot system, comprising:
a vehicle main body;
a grasping mechanism, comprising a mechanical arm assembly and a manipulator assembly, wherein the manipulator assembly is configured to grasp objects, the mechanical arm assembly comprises a first shaft body, a second shaft body, a third shaft body, and a fourth shaft body connected end to end sequentially, the first shaft body is disposed at a top end of the vehicle main body, the fourth shaft body is connected to the manipulator assembly, and the four shaft bodies all have a degree of freedom greater than 0 to drive the manipulator assembly to move in any direction; and
a material tray, symmetrically disposed on both sides of the vehicle main body, wherein the material tray comprises a fixed material tray fixedly disposed on the vehicle main body and a sliding material tray slidably disposed on the vehicle main body in a first direction, both the fixed material tray and the sliding material tray are provided with at least three loading stations, the vehicle main body is provided with an initial position located directly below the fixed material tray and a feeding position located on one side of the fixed material tray in the first direction, and the sliding material tray is configured to move between the initial position and the feeding position, wherein
the sliding material tray moves from the initial position to the feeding position while the grasping mechanism grasps the object, and the grasping mechanism places the grasped object on the loading station of the sliding material tray located at the feeding position;
the object comprises a wafer cassette and a tray carrier, several first blocking members and several second blocking members are disposed in the loading station, the first blocking member defines a first position for limiting the wafer cassette in an enclosing manner, the second blocking member encloses a periphery of the first blocking member, the second blocking member defines a second position for limiting the tray carrier in an enclosing manner, and at least part of the second blocking member extends above the first blocking member,
wherein a corner of the wafer cassette abuts against the first blocking member, and the first blocking member is of a first hollow structure with a third detection mechanism disposed therein for detecting whether a position of the wafer cassette is aligned with the first blocking member;
a corner of the tray carrier abuts against the second blocking member, and the second blocking member is of a second hollow structure with a fourth detection mechanism disposed therein for detecting whether a position of the tray carrier is aligned with the second blocking member.

2. The robot system according to claim 1, wherein a plurality of sliding material trays are provided, and each sliding material tray is provided with a plurality of loading stations.

3. The robot system according to claim 2, further comprising a first detection mechanism, wherein the first detection mechanism is disposed on the loading station and configured to transmit a first detection signal in a second direction to detect whether the object is located on the loading station,
wherein a preset included angle is maintained between the second direction and the first direction.

4. The robot system according to claim 3, further comprising a main controller and a second detection mechanism, wherein the second detection mechanism is configured to detect a quantity of the objects located on the loading stations of the sliding material tray;
the first detection mechanism detects that the objects are located on the loading stations and transmits in-position signals to the second detection mechanism, the second detection mechanism counts, within a preset time, a quantity of the in-position signals received and transmits the signals to the main controller, and the main controller determines whether a quantity of the objects located on the loading stations of the sliding material tray meets a preset quantity value based on the quantity of the in-position signals;
if so, the sliding material tray on which the objects are placed is reset from the feeding position to the initial position.

5. The robot system according to claim 4, wherein if the quantity of the objects located on the loading stations of the sliding material tray does not meet the preset quantity value, the grasping mechanism continues to grasp the objects and places the objects on the loading stations of the sliding material tray at the feeding position until the main controller determines that a quantity of the objects located on the loading stations of the sliding material tray reaches the preset quantity value, and then the grasping mechanism stops.

6. The robot system according to claim 1, wherein the manipulator assembly comprises at least one pair of grasping units; adjacent grasping units move in a direction distal to each other to engage a snap-fit structure at a top end of the object, or move in directions proximal to each other to disconnect the grasping units from the snap-fit structure and release the object.

7. The robot system according to claim 1, wherein the grasping mechanism further comprises a plurality of groups of connecting mechanisms, one end of the connecting mechanism is connected to one end of the shaft body distal to the vehicle main body, and the other end of the connecting mechanism is connected to the manipulator assembly with different specifications.

8. The robot system according to claim 1, further comprising a stage and a sliding mechanism, wherein the sliding material tray is disposed below the fixed material tray and mounted on a surface of the stage through the sliding mechanism;
the sliding mechanism comprises a sliding rail and a sliding stage disposed on the sliding rail, and the sliding material tray moves along the sliding rail through the sliding stage.
